(19) United States
(12) Patent Application Publication
(10) Pub. No.: US 2026/0164300 A1
(43) Pub. Date: Jun. 11, 2026

(54) RADIO LINK FAILURE TRIGGERED BUFFER STATUS REPORT IN MULTIPATH OPERATION

(71) Applicant: Nokia Technologies Oy, Espoo (FI)

(72) Inventors: SunYoung LEE, Seoul (KR); Vinh VAN PHAN, Oulu (FI); György Tamás WOLFNER, Budapest (HU); Faranaz SABOURI-SICHANI, Aalborg (DK)

(21) Appl. No.: 19/126,733

(22) PCT Filed: Aug. 2, 2023
(86) PCT No.: PCT/EP2023/071355

§ 371 Date: May 2, 2025

Related U.S. Application Data
(60) Provisional application No. 63/421,828, filed on Nov. 2, 2022.

(51) Int. Cl. H04W 28/02; H04W 76/18

(52) U.S. Cl. CPC H04W 28/0278; H04W 76/18

(57) ABSTRACT

Systems, methods, apparatuses, and computer program products for buffer status reporting triggered by radio link failure in scenarios involving multipath operation of a user equipment are provided. For example, a method can include communicating with a network over a plurality of paths, respective paths of the plurality of paths comprising a first radio link of the user equipment and a second radio link of the user equipment. The method can also include detecting, or predicting, radio link failure of the first radio link. The method can further include triggering a buffer status report to the network based on the detection or prediction of the radio link failure.

### FIELD

Some example embodiments may generally relate to communications including mobile or wireless telecommunication systems, such as Long Term Evolution (LTE) or fifth generation (5G) radio access technology or new radio (NR) access technology, or other communications systems including subsequent generations of the same or similar standards. For example, certain example embodiments may generally relate to buffer status reporting triggered by radio link failure in scenarios involving multipath operation of a user equipment.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. 5G wireless systems refer to the next generation (NG) of radio systems and network architecture. A 5G system is mostly built on a 5G new radio (NR), but a 5G (or NG) network can also build on the E-UTRA radio. From release 18 (Rel-18) onward, 5G is referred to as 5G advanced. It is estimated that NR provides bitrates on the order of 10-20 Gbit/s or higher, and can support at least service categories such as enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. The next generation radio access network (NG-RAN) represents the RAN for 5G, which can provide both NR and LTE (and LTE-Advanced) radio accesses. It is noted that, in 5G, the nodes that can provide radio access functionality to a user equipment (i.e., similar to the Node B, NB, in UTRAN or the evolved NB, eNB, in LTE) may be named next-generation NB (gNB) when built on NR radio and may be named next-generation eNB (NG-eNB) when built on E-UTRA radio. 6G is currently under development and may replace 5G and 5G advanced.

### SUMMARY

An embodiment may be directed to an apparatus. The apparatus may include at least one processor and at least memory storing instructions. The instructions, when executed by the at least one processor, may cause the apparatus at least to perform communicating with a network over a plurality of paths. Respective paths of the plurality of paths can include a first radio link of the apparatus and a second radio link of the apparatus. The instructions, when executed by the at least one processor, can further cause the apparatus at least to perform detecting, or predicting, a radio link failure of the first radio link. The instructions, when executed by the at least one processor, can further cause the apparatus at least to perform triggering a buffer status report to the network based on the detection or prediction of the radio link failure.

An embodiment may be directed to a method. The method can include communicating with a network over a plurality of paths. Respective paths of the plurality of paths can include a first radio link of a user equipment and a second radio link of the user equipment. The method can also include detecting, or predicting, a radio link failure of the first radio link. The method can further include triggering a buffer status report to the network based on the detection or prediction of the radio link failure.

An embodiment can be directed to an apparatus. The apparatus can include means for communicating with a network over a plurality of paths. Respective paths of the plurality of paths can include a first radio link of the apparatus and a second radio link of the apparatus. The apparatus can also include means for detecting, or means for predicting, a radio link failure of the first radio link. The apparatus can further include means for triggering a buffer status report to the network based on the detection or prediction of the radio link failure.

### BRIEF DESCRIPTION OF THE DRAWINGS

For proper understanding of example embodiments, reference should be made to the accompanying drawings, wherein:

FIG. 1A illustrates an example set of rules to provide an example implementation of certain embodiments;

FIG. 1B illustrates another example set of rules to provide an example implementation of certain embodiments;

FIG. 1C illustrates an example set of rules to provide an example implementation of certain embodiments;

FIG. 2 illustrates a method according to certain embodiments; and

FIG. 3 illustrates an example block diagram of a system, according to an embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for providing buffer status reporting triggered by radio link failure in scenarios involving multipath operation of a user equipment, is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

Certain embodiments may have various aspects and features. These aspects and features may be applied alone or in any desired combination with one another. Other features, procedures, and elements may also be applied in combination with some or all of the aspects and features disclosed herein.

Additionally, if desired, the different functions or procedures discussed below may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

Certain embodiments relate to buffer status reporting (BSR) to support multipath scenarios. The multipath scenarios being described here are scenarios in which there is deliberate use of a plurality of paths, as distinct from the interference and phase-shifting scenario in which there can be Raleigh fading or the like caused by, for example, reflection, refraction, or the like of a signal. For example, in certain embodiments the UE can be configured with at least two paths to be used for transmission and reception of data to and from the gNB. Specifically, the paths can include a direct path and an indirect path for sidelink (SL) multipath (MP) scenarios.

Third generation partnership project (3GPP) technical specification (TS) 38.321 defines various trigger events for sidelink buffer status report (SL-BSR) for the standard. For example, SL-BSR can be triggered based on SL data arrival, SL data presence, padding, and based on some SL-BSR control timers such as retransmission timer and periodic timer.

Likewise, 3GPP TS 38.321 also defines various trigger events for uplink buffer status report (UL-BSR). UL-BSR can be triggered based on UL data arrival, priority of UL data, padding, and based on some UL-BSR control timers such as retransmission timer and periodic timer.

In certain embodiments, a UE may be connected to the same gNB using one direct path and one indirect path either via layer-2 (L2) UE-to-network relay, or via another UE.

In sidelink MP relay, the gNB can manage use of multipath by considering reliability and throughput. Thus, the gNB may need to have updated information regarding channel quality or buffer status for better deciding the switching, releasing, and/or addition of multipath.

When there is multipath from the UE to the gNB, the radio link failure on one path does not necessarily mean that the UE recovers the failure by RRC connection re-establishment.

After failure detection on one path, the gNB may need to determine whether to switch the concerned path or to release the path. For example, the gNB may not to determine whether to continue MP operation or not. This decision may take in account the radio quality and/or buffered data amount. However, the buffer status report is triggered based on timer while the data is on-going. For example, the BSR may be triggered by a periodic timer or retransmission timer. As a result, there may be delay between path failure and the next trigger of a BSR. In addition, the gNB may not exactly know how much data is steered via the indirect path because transmission over the PC5 interface for a multi-path split RB, which is transmitted via either the direct path and the indirect path, may be up to UE implementation and not known to the gNB. These may result in delayed decision or a decision made without knowing the buffer status accurately from the gNB side, which may cause unnecessary reconfiguration of multi-path operation, including failure to restore the indirect path upon failure of the indirect path.

One solution would be that the gNB waits for the UE to send the BSR before deciding whether to keep the multipath relay operation or not, which prevents fast recovery of failure on one path and may result in decreased performance in terms of throughput and reliability. Another solution would be that the gNB decides whether to keep the multipath relay operation or not without caring the buffered data amount in the UE side or based on the outdated buffered data amount. The drawback of this approach is that the gNB may need to reconfigure the multipath operation after the updated BSR is received from the UE.

Certain embodiments relate to triggering a BSR when a failure is detected on a path among the multiple paths between a UE and a gNB. For example, there may be at least one path other than the problematic path still available. For example, the path through sidelink may fail, but the direct path may not be suspended or no failure may be detected. If the UE is configured and operating with multi-paths using a sidelink relay, the failure can be detected over the Uu interface of the UE, the PC5 interface between the UE and the sidelink relay, or the Uu interface of the sidelink relay.

When the interface between the UE and the sidelink relay is not a 3GPP interface, any suitable mechanism for detection of the failure over this non-3GPP interface can be used. It can be known by the 3GPP entity in the UE whether there is failure or not over this non-3GPP interface by implementation. The failure over indirect path can be detected when, for instance, a maximum number of retransmission for a specific destination has been reached, upon indication from medium access control (MAC) that a maximum number of consecutive hybrid automatic repeat request (HARQ) discontinuous transmission (DTX) for a specific destination has been reached, integrity check failure has occurred from sidelink packet data convergence protocol (PDCP) for SL-SRB2/3 for a specific destination, and/or any other condition specified in 3GPP TS 38.331. The failure over direct path can be detected when, for instance, a random access problem or a maximum number of retransmissions in radio link control (RLC) has been reached, as specified in 3GPP TS 38.331. Other mechanisms or conditions for detecting or predicting radio link failure are also permitted.

Certain embodiments relate to triggering of respectively UL-BSR or SL-BSR based on the path where a failure is detected. For example, if failure is detected on an indirect path, the UE can trigger SL-BSR. If failure is detected on a direct path, the UE can trigger UL-BSR. When MAC level signaling is used for reporting the buffer size, whether the BSR MAC CE is for SL-BSR or UL-BSR can be indicated by a corresponding logical channel identifier (LCID). For this, a value of LCID for sidelink shared channel (SL-SCH) can be defined to indicate UL-BSR.

In certain embodiments, the BSR can be sent through a path that is not suspended and/or no failure is detected. For example, the BSR can be sent through a path without detected radio link failure, which works normally. If the UE is configured and operating with one direct path and one indirect path, and the failure is detected on the direct path only, the BSR can be reported through the indirect path to the gNB. If the failure is detected on the indirect path only, the BSR can be reported though the direct path. If there are more than two paths, the UE can send the BSR through any path of the alive paths, for example any path among the paths that is not suspended and/or no failure is detected. If the failure is detected on one path and there is no other path available for transmission of the BSR, such that transmission is suspended, the UE may not trigger the BSR even when the failure is detected.

In certain embodiments, a BSR is triggered when a radio link failure is predicted on a path among the multiple paths between a UE and a gNB. In this example, the BSR may be transmitted using the same path where the radio link failure (RLF) is predicted or over another path. The UE may utilize UE-defined or network-configured metrics to predict an upcoming radio link failure. Such metrics could be based on one or more RLF parameters, like N310 start, a pre-defined or configured number of out-of-sync indications to higher layers, or T310 expiry. The prediction may be further dependent on the UE's mobility and the Uu or sidelink reference signal received power (SL-RSRP) slope, or the RSRP reduction over given time. This measurement may provide an indication to the UE that the UE's Uu link or PC5 link is deteriorating rapidly, as the UE may be moving fast away from a gNB cell center or the relay UE or towards a cell edge or other out-of-coverage scenario.

Certain embodiments may including indicating buffer size for a subset of radio bearers (RBs) in the BSR. When the UE is operating with sidelink multi-path (SL MP) of one direct path and one indirect path, the UE can be configured with an RB that is one of three types: direct RB, indirect RB, and multi-path (MP) split RB. If the UE detects the failure on any path, the UE can indicate the buffer size of the MP split RB.

When indicating the buffer size of the MP split RB, only the data from a logical channel associated with the concerned path may be considered. For example, if UL-BSR is triggered, the UE may only consider the data from the logical channel associated with the direct path. If SL-BSR is triggered, the UE may only consider the data from the logical channel associated with the indirect path.

Additionally, if the UE detects the failure on the direct path, the UE may further indicate the buffer size of the direct RB. However, the UE may not indicate the buffer size of the indirect RB. Likewise, if the UE detects the failure on the indirect path, the UE may further indicate the buffer size of the indirect RB. However, the UE may not indicate the buffer size of the direct RB.

If there is no data available for transmission for MP split RB, the UE may either cancel the BSR or report the buffer size as zero. If there is no data available for transmission for direct RB or indirect RB, the UE may not cancel the BSR but may instead report the buffer size as zero, as long as the BSR is not cancelled by the MP split RB having no data available for transmission.

In certain embodiments, the trigger of the BSR is restricted, such that the UE triggers the BSR if there is no BSR triggered and/or sent within a certain duration before detecting a failure on one path. For example, the BSR is not automatically triggered when the failure on one path is detected within the certain duration after triggering/reporting the last BSR to the gNB. Alternatively, the UE may trigger the BSR if the UE is configured with at least one MP split RB. Thus, for example, the UE may not trigger the BSR if the UE is configured with no MP split RB. Alternatively, the UE may trigger the BSR if the buffer size at the time of RLF detection is changed over a certain amount compared to a most recently reported buffer size. For instance, if the buffer size is more than a threshold more than the last reported to the gNB, then BSR may be triggered. For example, the UE may trigger the BSR if the buffer size is larger than the last reported buffer size by X bytes, or the UE may trigger the BSR if the buffer size level is changed compared to the last reported buffer size level.

In certain embodiments, the sending of the triggered BSR may be performed before sending the failure information to the gNB or together with the failure information that is to be sent to the gNB. If the BSR is to be sent before sending the failure information, the MAC CE format can be used. If the BSR is to be sent together with the failure information, the BSR can be either the MAC CE or the RRC signaling.

In certain embodiments, there can be prioritization of a logical channel group (LCG) of having a logical channel associated with an RB of which the type is MP split type. This prioritization can be applied when generating a BSR MAC CE.

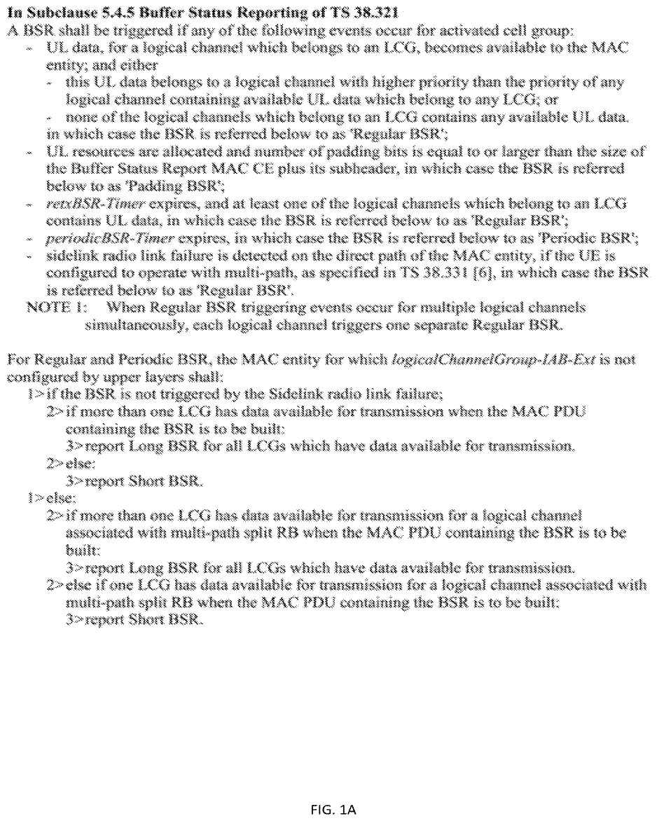

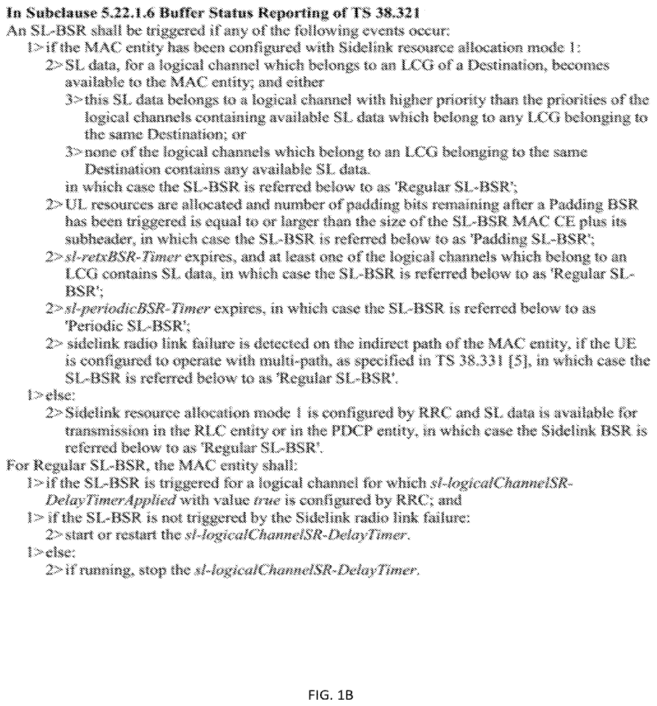

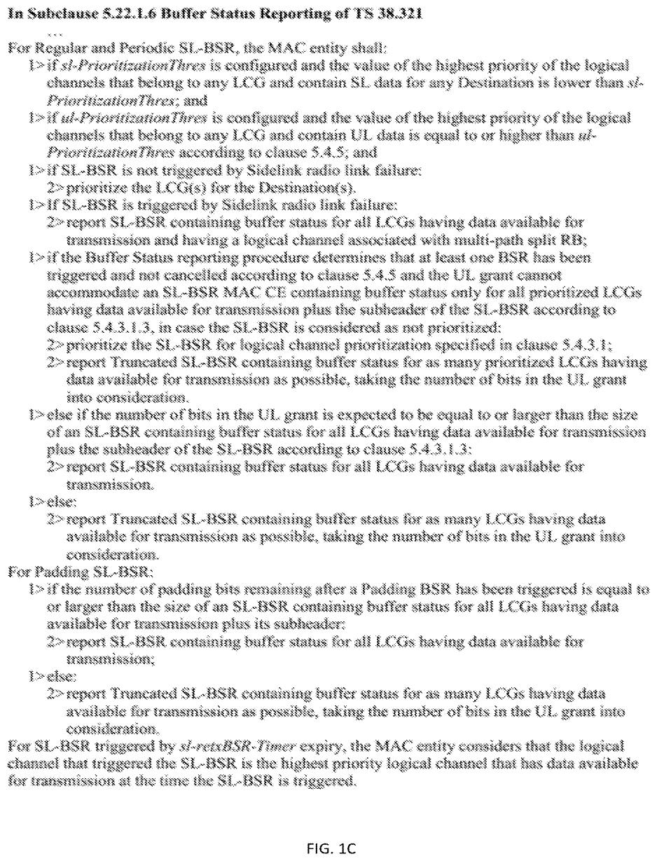

FIG. 1A illustrates an example set of rules to provide an example implementation of certain embodiments. As shown in FIG. 1A, the rules may include rules found in 3GPP TS 38.321 v17.2.0 but may also dictate that a BSR is triggered when sidelink radio link failure is detected on the direct path of the MAC entity, if the UE is configured to operate with multi-path, as specified in 3GPP TS 38.331, in which case the BSR can be referred to as ‘Regular BSR’. Additionally, there may be further prioritization rules. For example, if more than one LCG has data available for transmission for a logical channel associated with multi-path split RB when the MAC PDU containing the BSR is to be built, then the UE can report Long BSR for all LCGs that have data available for transmission. Otherwise, if one LCG has data available for transmission for a logical channel associated with multi-path split RB when the MAC PDU containing the BSR is to be built, then short BSR can be reported.

FIG. 1B illustrates another example set of rules to provide an example implementation of certain embodiments. As shown in FIG. 1B, the rules may include rules found in 3GPP TS 38.321 v17.2 but may also dictate that a SL-BSR is to be triggered when sidelink radio link failure is detected on the indirect path of the MAC entity, if the UE is configured to operate with multi-path, as specified in 3GPP TS 38.331, in which case the SL-BSR can be referred to as ‘Regular SL-BSR’.

FIG. 1C illustrates yet another example set of rules to provide an example implementation of certain embodiments. FIG. 1C can be understood as a continuation of the same set of rules from FIG. 1B. The rules may include rules found in 3GPP TS 38.321 but may further include a rule that if the SL-BSR is triggered by sidelink radio link failure, the UE is to report SL-BSR containing buffer status for all LCGs having data available for transmission and having a logical channel associated with multi-path split RB(s).

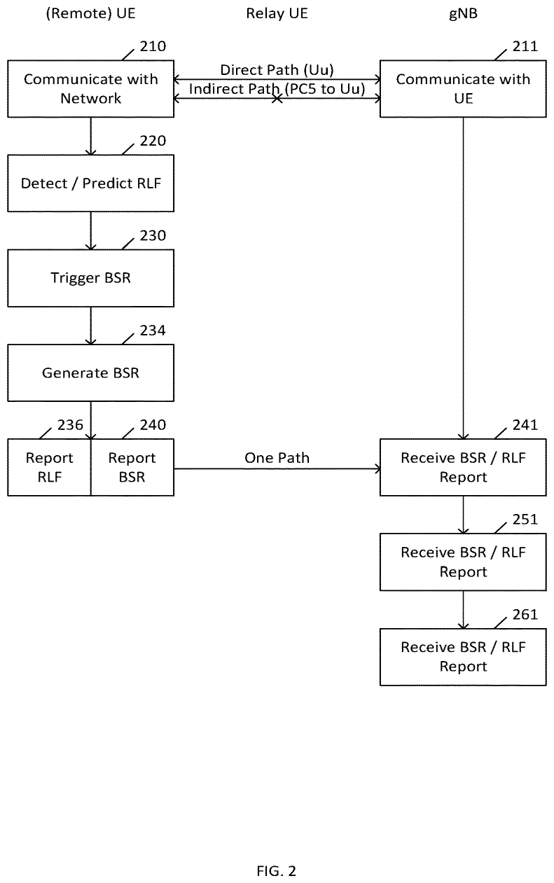

FIG. 2 illustrates a method according to certain embodiments. As shown in FIG. 2, a method can include, at 210, communicating with a network over a plurality of paths, respective paths of the plurality of paths comprising a first radio link of a user equipment and a second radio link of the user equipment.

The method can also include, at 220, detecting, or predicting, radio link failure of the first radio link.

The method can further include, at 230, triggering a buffer status report to the network based on the detection or prediction of the radio link failure.

The triggering the buffer status can include triggering an uplink buffer status report when the first radio link failure is failure of a direct path to the network. The triggering the buffer status report can include triggering a sidelink buffer status report when the first radio link failure is failure of an indirect path to the network.

The method can further include, at 240, sending the buffer status report. The sending the buffer status report can be performed over an indirect path to the network when the first radio link failure is a detected failure of a direct path to the network. As another option, the sending the buffer status report can performed over a direct path to the network when the first radio link failure is a detected failure of an indirect path to the network. The sending the buffer status report can be performed over the first radio link when the radio link failure is a predicted failure.

The buffer status report can include an indication of a buffer size of for a subset of radio bearers used by the user equipment.

The triggering can additionally be based on the absence of at least one of the triggering or transmission of another buffer status report within a predetermined timeframe before the detection or prediction of the radio link failure.

The method can also include at, 236, reporting the buffer status report together with, or before, reporting the detected radio link failure.

The method can further include, at 234, generating, based on the triggering, the buffer status report message having prioritized logical channel groups. A logical channel group can be prioritized based on having a logical channel associated with a radio bearer of a multipath split type.

The first radio link and the second radio link can each include at least one of a first Uu interface between the user equipment and the network, a PC5 interface between the user equipment and a relay user equipment, or second Uu interface between the relay user equipment and the network.

The above-described procedures of FIG. 2 may be performed by the user equipment. Additional procedures may be performed by the network. The method may include, at 211, communicating with a user equipment over the plurality of paths, the respective paths of the plurality of paths comprising the first radio link of the user equipment and a second radio link of the user equipment. These may be the same paths mentioned described with reference to procedure 210.

At 241, the network can receive the buffer status report from the user equipment based on the detection or the prediction of radio link failure of the first radio link.

At 251, the method can include determining handling of the plurality of paths based on the buffer status report. Accordingly, at 261, the method can include controlling subsequent communication with the user equipment based on the determination.

The determining handling can include determining to reestablish the first radio link based on the indication of the buffer size for the subset of radio bearers. In such a case, the controlling communication at 261 can include reestablishing the first radio link.

When the buffer status report has prioritized logical channel groups, with a logical channel group being prioritized based on having a logical channel associated with a radio bearer of a multipath split type, the determining handling can include determining to reestablish the first radio link based on presence of data for the logical channel group having the logical channel associated with the radio bearer of a multipath split type.

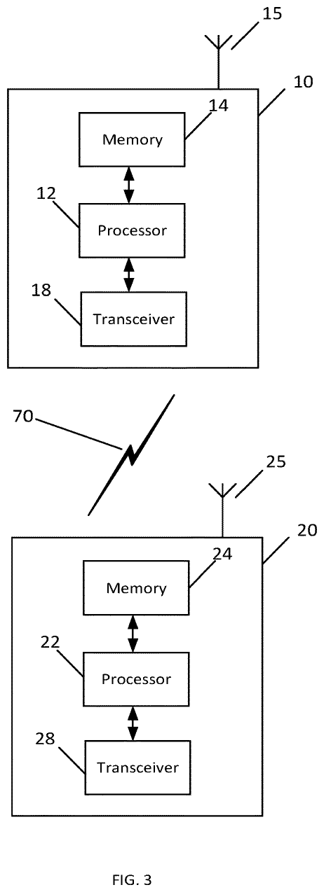

FIG. 3 illustrates an example of a system that includes an apparatus 10, according to an embodiment. In an embodiment, apparatus 10 may be a node, host, or server in a communications network or serving such a network. For example, apparatus 10 may be a network node, satellite, base station, a Node B, an evolved Node B (eNB), 5G Node B or access point, next generation Node B (NG-NB or gNB), TRP, HAPS, integrated access and backhaul (IAB) node, and/or a WLAN access point, associated with a radio access network, such as a LTE network, 5G or NR. In some example embodiments, apparatus 10 may be gNB or other similar radio node, for instance.

It should be understood that, in some example embodiments, apparatus 10 may include an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a mid-haul interface, referred to as an F1 interface, and the DU(s) may have one or more radio unit (RU) connected with the DU(s) over a front-haul interface. The DU may be a logical node that includes a subset of the gNB functions, depending on the functional split option. It should be noted that one of ordinary skill in the art would understand that apparatus 10 may include components or features not shown in FIG. 3.

As illustrated in the example of FIG. 3, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, or any other processing means, as examples. While a single processor 12 is shown in FIG. 3, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to buffer status reporting triggered by radio link failure in scenarios involving multipath operation of a user equipment.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be include any combination of random access memory (RAM), read only memory (ROM), static storage such as a magnetic or optical disk, hard disk drive (HDD), or any other type of non-transitory machine or computer readable media, or other appropriate storing means. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15, or may include any other appropriate transceiving means. The radio interfaces may correspond to a plurality of radio access technologies including one or more of global system for mobile communications (GSM), narrow band Internet of Things (NB-IoT), LTE, 5G, WLAN, Bluetooth (BT), Bluetooth Low Energy (BT-LE), near-field communication (NFC), radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (via an uplink, for example).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device), or an input/output means.

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry/means or control circuitry/means. In addition, in some embodiments, transceiver 18 may be included in or may form a part of transceiver circuitry/means.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be or may be a part of a network element or RAN node, such as a base station, access point, Node B, eNB, gNB, TRP, HAPS, IAB node, relay node, WLAN access point, satellite, or the like. In one example embodiment, apparatus 10 may be a gNB or other radio node, or may be a CU and/or DU of a gNB. According to certain embodiments, apparatus 10 may be controlled by memory 14 and processor 12 to perform the functions associated with any of the embodiments described herein. For example, in some embodiments, apparatus 10 may be configured to perform one or more of the processes depicted in any of the flow charts or signaling diagrams described herein, such as those illustrated in FIGS. 1A to 2, or any other method described herein. In some embodiments, as discussed herein, apparatus 10 may be configured to perform a procedure relating to providing buffer status reporting triggered by radio link failure in scenarios involving multipath operation of a user equipment, for example.

FIG. 3 further illustrates an example of an apparatus 20, according to an embodiment. In an embodiment, apparatus 20 may be a node or element in a communications network or associated with such a network, such as a UE, communication node, mobile equipment (ME), mobile station, mobile device, stationary device, IoT device, or other device. As described herein, a UE may alternatively be referred to as, for example, a mobile station, mobile equipment, mobile unit, mobile device, user device, subscriber station, wireless terminal, tablet, smart phone, IoT device, sensor or NB-IoT device, a watch or other wearable, a head-mounted display (HMD), a vehicle, a drone, a medical device and applications thereof (e.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 20 may be implemented in, for instance, a wireless handheld device, a wireless plug-in accessory, or the like.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 3.

As illustrated in the example of FIG. 3, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 3, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can include any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDM symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR.

According to some embodiments, processor 22 and memory 24 may be included in or may form a part of processing circuitry or control circuitry. In addition, in some embodiments, transceiver 28 may be included in or may form a part of transceiving circuitry.

As discussed above, according to some embodiments, apparatus 20 may be a UE, SL UE, relay UE, mobile device, mobile station, ME, IoT device and/or NB-IoT device, or the like, for example. According to certain embodiments, apparatus 20 may be controlled by memory 24 and processor 22 to perform the functions associated with any of the embodiments described herein, such as one or more of the operations illustrated in, or described with respect to, FIGS. 1A to 2, or any other method described herein. For example, in an embodiment, apparatus 20 may be controlled to perform a process relating to providing buffer status reporting triggered by radio link failure in scenarios involving multipath operation of a user equipment, as described in detail elsewhere herein.

In some embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of any of the operations discussed herein.

In view of the foregoing, certain example embodiments provide several technological improvements, enhancements, and/or advantages over existing technological processes and constitute an improvement at least to the technological field of wireless network control and/or management. Certain embodiments may provide various benefits and/or advantages. For example, by immediately providing the gNB with the updated buffer size information, sidelink resources and/or uplink resources can be reallocated to other UEs requiring more resources, which may lead to network capacity improvement.

In some example embodiments, the functionality of any of the methods, processes, signaling diagrams, algorithms or flow charts described herein may be implemented by software and/or computer program code or portions of code stored in memory or other computer readable or tangible media, and may be executed by a processor.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components which, when the program is run, are configured to carry out some example embodiments. The one or more computer-executable components may be at least one software code or portions of code. Modifications and configurations required for implementing the functionality of an example embodiment may be performed as routine(s), which may be implemented as added or updated software routine(s). In one example, software routine(s) may be downloaded into the apparatus.

As an example, software or computer program code or portions of code may be in source code form, object code form, or in some intermediate form, and may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium. The term “non-transitory” as used herein, is a limitation of the medium itself (i.e. tangible, not a signal) as opposed to a limitation on data storage persistency (e.g. RAM vs. ROM).

In other example embodiments, the functionality of example embodiments may be performed by hardware or circuitry included in an apparatus, for example through the use of an application specific integrated circuit (ASIC), a programmable gate array (PGA), a field programmable gate array (FPGA), or any other combination of hardware and software. In yet another example embodiment, the functionality of example embodiments may be implemented as a signal, such as a non-tangible means, that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein may apply to both singular and plural implementations, regardless of whether singular or plural language is used in connection with describing certain embodiments. For example, an embodiment that describes operations of a single network node may also apply to example embodiments that include multiple instances of the network node, and vice versa.

One having ordinary skill in the art will readily understand that the example embodiments as discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

### PARTIAL GLOSSARY

BS Buffer Status
BSR Buffer Status Reporting
MP Multi-path
SL-BSR Sidelink Buffer Status Reporting
UL-BSR Uplink Buffer Status Reporting
RB Radio Bearer

1. An apparatus, comprising:
at least one processor; and
at least one memory storing instructions that, when executed by the at least one processor, cause the apparatus at least to perform
communicating with a network over a plurality of paths, respective paths of the plurality of paths comprising a first radio link of the apparatus and a second radio link of the apparatus;
detecting, or predicting, a radio link failure of the first radio link; and
triggering a buffer status report to the network based on the detection or prediction of the radio link failure.

2. The apparatus of claim 1, wherein triggering the buffer status report comprises at least one of:
triggering an uplink buffer status report when the first radio link failure is failure of a direct path to the network; or triggering a sidelink buffer status report when the first radio link failure is failure of an indirect path to the network.

3. The apparatus of claim 1, wherein the instructions, when executed by the at least one further cause the apparatus at least to perform one of:
sending the buffer status report over an indirect path to the network when the first radio link failure is a detected failure of a direct path to the network;
sending the buffer status report over a direct path to the network when the first radio link failure is a detected failure of an indirect path to the network; or
sending the buffer status report over the first radio link when the radio link failure is a predicted failure.

4. The apparatus of any of claims 1 to 3, wherein the buffer status report comprises an indication of a buffer size of for a subset of radio bearers used by the apparatus.

5. The apparatus of claim 4, wherein the subset comprises a set of multi-path split radio bearers.

6. The apparatus of any of claims 1 to 5, wherein the triggering is additionally based on the absence of at least one of the triggering or transmission of another buffer status report within a predetermined timeframe before the detection or prediction of the radio link failure.

7. The apparatus of any of claims 1 to 6, wherein the instructions, when executed by the at least one further cause the apparatus at least to perform
reporting the buffer status report together with, or before, reporting the detected radio link failure.

8. The apparatus of any of claims 1 to 7, wherein the instructions, when executed by the at least one further cause the apparatus at least to perform
generating, based on the triggering, the buffer status report message having prioritized logical channel groups, wherein a logical channel group is prioritized based on having a logical channel associated with a radio bearer of a multipath split type.

9. The apparatus of any of claims 1 to 8, wherein the first radio link and the second radio link each comprises at least one of a first Uu interface between the apparatus and the network, a PC5 interface between the apparatus and a relay user equipment, or second Uu interface between the relay user equipment and the network.

10. A method, comprising:
communicating with a network over a plurality of paths, respective paths of the plurality of paths comprising a first radio link of a user equipment and a second radio link of the user equipment;
detecting, or predicting, a radio link failure of the first radio link; and
triggering a buffer status report to the network based on the detection or prediction of the radio link failure.

11. The method of claim 10, wherein triggering the buffer status report comprises at least one of:
triggering an uplink buffer status report when the first radio link failure is failure of a direct path to the network; or triggering a sidelink buffer status report when the first radio link failure is failure of an indirect path to the network.

12. The method of claim 10, further comprising at least one of:
sending the buffer status report over an indirect path to the network when the first radio link failure is a detected failure of a direct path to the network; sending the buffer status report over a direct path to the network when the first radio link failure is a detected failure of an indirect path to the network; or
sending the buffer status report over the first radio link when the radio link failure is a predicted failure.

13. The method of any of claims 10 to 12, wherein the buffer status report comprises an indication of a buffer size of for a subset of radio bearers used by the user equipment.

14. The method of claim 13, wherein the subset comprises a set of multi-path split radio bearers.

15. The method of any of claims 10 to 14, wherein the triggering is additionally based on the absence of at least one of the triggering or transmission of another buffer status report within a predetermined timeframe before the detection or prediction of the radio link failure.

16. The method of any of claims 10 to 15, further comprising:
reporting the buffer status report together with, or before, reporting the detected radio link failure.

17. The method of any of claims 10 to 16, further comprising:
generating, based on the triggering, the buffer status report message having prioritized logical channel groups, wherein a logical channel group is prioritized based on having a logical channel associated with a radio bearer of a multipath split type.

18. The method of any of claims 10 to 17, wherein the first radio link and the second radio link each comprises at least one of a first Uu interface between the user equipment and the network, a PC5 interface between the user equipment and a relay user equipment, or second Uu interface between the relay user equipment and the network.

19. An apparatus, comprising:
means for performing the method of any of claims 10-18.

20. A computer program product encoding instructions for performing the method of any of claims 10-18.

21. A non-transitory computer-readable medium encoded with instructions that, when executed in hardware, perform the method of any of claims 10-18.
